(19) United States
(12) Patent Application Publication
(10) Pub. No.: US 2006/0198011 A1
(43) Pub. Date: Sep. 7, 2006

(54) Volumetric three-dimensional device using two-dimensional scanning device

(75) Inventors: Cheong Soo Seo, Seoul (KR); Gyoung Il Cho, Seoul (KR); Sang Hyune Baek, Seoul (KR)

Correspondence Address: Law Offices of Park & Associates;Suite 1722, 3600 Wilshire Blvd., Los Angeles, CA, 90010, US

(73) Assignees: STEREO DISPLAY, INC.; ANGSTROM, INC.

(21) Appl. No.: 11/072,557

(22) Filed: Mar. 4, 2005

(51) Int. Cl. G02B 26/00

(52) U.S. Cl. 359/291

(57) ABSTRACT

A display apparatus includes an array of micromirror array lenses, configured to focus incident light beams onto a two-dimensional screen. The two-dimensional screen is optically coupled to the array of micromirror array lenses, configured to display a two-dimensional image to be used by a volumetric three-dimensional display device, based at least in part on the incident light beams focused by the array of micromirror array lenses onto the two-dimensional screen. In one aspect, the optical axis of at least a portion of the array of micromirror array lenses is adjusted by translation and/or rotation of the at least a portion of the array of micromirror array lenses. The advantages of the present invention include improved brightness of image and increased light efficiency, resulting in lower power consumption.

### FIELD OF THE INVENTION

The present invention relates to display devices in general and more specifically to a two-dimensional display device as a part of a volumetric three-dimensional display system.

### BACKGROUND OF THE INVENTION

FIGS. 1A-D illustrate a prior art three-dimensional display principle of a volumetric three-dimensional technique. In the embodiments depicted in FIGS. 1A-D, a two-dimensional display device (two-dimensional screen) 101 makes a first image for a volumetric three-dimensional image. An all in-focus image 102 is produced as a composite of in-focus images 102A-102C, which correspond to specific (pre-determined depth) focal lengths on object 104. A human eye 105 views the displayed image.

In some instances, a fast two-dimensional (first image) display apparatus which can display at least some number of depth levels times after-image speed of the human eye is desirable. For example, to implement 10 depth levels, the display device might need to display at least 300 frames per second (10×30). Certain types of prior art display devices, such as liquid crystal displays (LCD), are not capable of displaying images at such a high rate.

Furthermore, other problems with prior art display devices exist. For example, it is difficult to increase the brightness of a cathode ray tube (CRT) display, and it is difficult to reduce the size of a plasma display panel (PDP). Deformable mirror devices (DMD) seem to be a more promising solution for generating a first image for a volumetric three-dimensional display device than CRT or PDP. However, in the case of DMD, for each depth level, an in-focus image consists of only limited pixels in a display and the rest of the pixels are in an ‘OFF’ pixel. Therefore, the average brightness of the image is decreased with increasing depth level number. For example, to implement 10 depth levels, the average brightness becomes 1/10. To increase brightness of the image, more power is required. Therefore, if DMD is used for a first image device, almost 90% (for 10 depth levels) of the light is dumped because each display pixel corresponds to a deformable mirror. (Refer to FIG. 2 below).

FIG. 2 depicts a prior art two-dimensional display apparatus using a deformable mirror device to provide a first image of a volumetric three-dimensional display device. In the embodiment depicted in FIG. 2, a display apparatus 200 includes a deformable mirror device (DMD) 201, such as Texas Instruments® Digital Light Processing (DLP)™ technology. Incident light beams 202 are reflected from the DMD 201. This reflection yields light beams 203, directed to a two-dimensional screen 204 for making a desired in-focus image, where corresponding micromirrors in the DMD 201 are in an ‘ON’ pixel, and dumped light beams 204, where corresponding micromirrors in the DMD 201 are in an ‘OFF’ pixel. The dumped light beams 204 are wasted because there are no pixels constructing an image on corresponding positions in the in-focused image. For 10 depth levels, the average light used is about 1/10. Therefore, a significant percentage of the incident light beams 202 are not used and are dumped. The two-dimensional screen 204 displays a first image for use by a volumetric three-dimensional display device.

Therefore, what is needed is a display apparatus that allows for increase light efficiency.

### SUMMARY OF INVENTION

The present invention addresses the problems of the prior art and provides a volumetric three-dimensional (3-D) device using a two-dimensional (2-D) scanning device (display apparatus or display device). The following US patent applications describe micromirrors and micromirror array lens. U.S. patent application Ser. No. 10/778,281 (Docket No. 1802.01), filed Feb. 13, 2004, U.S. patent application Ser. No. 10/822,414 (Docket No. 1802.04), filed Apr. 12, 2004, U.S. patent application Ser. No. 10/857,714 (Docket No. 1802.09), filed May 28, 2004, U.S. patent application Ser. No. 10/914,474 (Docket No. 1802.15), filed Aug. 9, 2004, all of which are hereby incorporated by reference.

In one embodiment, a display apparatus includes an array of micromirror array lenses, configured to focus incident light beams onto a two-dimensional screen. The two-dimensional screen is optically coupled to the array of micromirror array lenses, configured to display a two-dimensional image to be used by a volumetric three-dimensional display device, based at least in part on the incident light beams focused by the array of micromirror array lenses onto the two-dimensional screen.

In one aspect of the present invention, the optical axis of at least a portion of the array of micromirror array lenses is adjusted by translation and/or rotation of the at least a portion of the array of micromirror array lenses.

In another aspect of the present invention, each micromirror of the array of micromirror array lenses is controlled independently. In this aspect, the optical axis of at least a portion of the array of micromirror array lenses may be adjusted by translation and/or rotation of a micromirror. Also in this aspect, the focal length of at least a portion of the array of micromirror array lenses may be adjusted by translation and/or rotation of a micromirror.

In another embodiment, a method in a display device includes focusing incident light beams onto a two-dimensional screen using an array of micromirror array lenses and displaying a two-dimensional image to be used by a volumetric three-dimensional display device, in response to the focusing of the incident light beams. In one aspect, the method further includes adjusting the optical axis of the array of micromirror array lenses. The adjusting of the optical axis may be performed by translating and/or rotating a micromirror. In another aspect, the method further includes adjusting the focal length of the array of micromirror array lenses. The adjusting of the focal length may be performed by translating and/or rotating a micromirror.

The advantages of the present invention include improved brightness of image and increased light efficiency, resulting in lower power consumption.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-D illustrate a prior art three-dimensional display principle of a volumetric three-dimensional technique;

FIG. 2 depicts a prior art two-dimensional display apparatus using a deformable mirror device to provide a first image of a volumetric three-dimensional display device; and

FIG. 3 depicts a two-dimensional display apparatus using an array of micromirror array lenses to provide a first image of a volumetric three-dimensional display device, according to an embodiment of the invention; and

FIG. 4 is a flow diagram of a method in a display device, according to an embodiment of the invention.

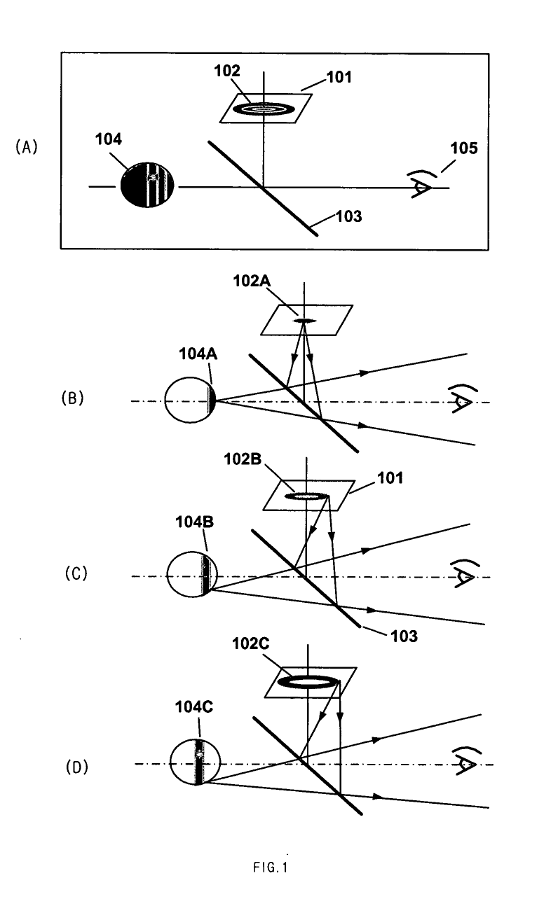

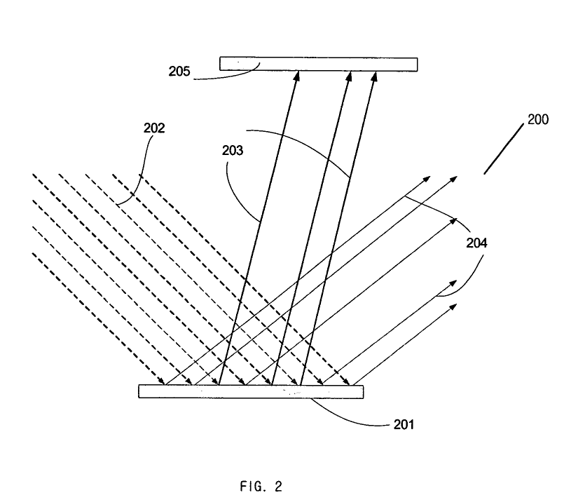

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

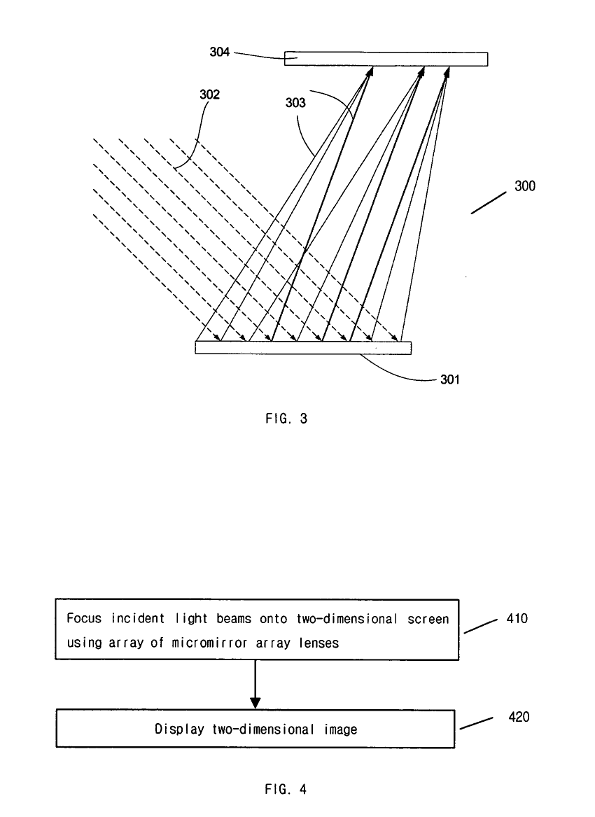

FIG. 3 depicts a two-dimensional display apparatus using an array of micromirror array lenses to provide a first image of a volumetric three-dimensional display device, according to an embodiment of the invention. An array of micromirror array lenses includes a plurality of micromirrors.

In the embodiment depicted in FIG. 3, a display apparatus 300 includes an array of micromirror array lenses 301, configured to focus incident light beams 302 onto a two-dimensional screen 304. When the incident light beams 302 are focused, focused light beams 303 directed at the two-dimensional screen are produced. The two-dimensional screen 304 is optically coupled to the array of micromirror array lenses 301 and configured to display a two-dimensional image to be used by a volumetric three-dimensional display device, based at least in part on the incident light beams focused by the array of micromirror array lenses 301 onto the two-dimensional screen 304.

In one embodiment, the optical axis of at least a portion of the array of micromirror array lenses is adjusted by translation and/or rotation of the at least a portion of the array of micromirror array lenses.

In another embodiment, each micromirror of the array of micromirror array lenses is controlled independently. In another embodiment, the optical axis of at least a portion of the array of micromirror array lenses is adjusted by translation and/or rotation of a micromirror. In another embodiment, the focal length of at least a portion of the array of micromirror array lenses is adjusted by translation and/or rotation of a micromirror.

By controlling the optical axis of the array of micromirror array lenses and regenerating lens formation, all incident light may be converged onto the two-dimensional screen 304. A bright image may thus be provided. Furthermore, in a prior art deformable mirror device (DMD), if a micromirror fails the corresponding pixel is lost permanently and the image is degraded. However, using the embodiments of the present invention, with an array of micromirror array lenses, other micromirrors can cover for failed micromirrors because each micromirror is controlled independently and may have its optical axis adjusted and may scan a two-dimensional plane.

FIG. 4 is a flow diagram of a method in a display device, according to an embodiment of the invention. At step 410, incident light beams are focused onto a two-dimensional screen using an array of micromirror array lenses. At step 420, a two-dimensional image to be used by a volumetric three-dimensional display device is displayed by the two-dimensional screen, in response to the focusing of the incident light beams.

In one embodiment, the method also includes adjusting the optical axis of the array of micromirror array lenses. The optical axis may be adjusted by translating and/or rotating a micromirror.

In another embodiment, the method also includes adjusting the focal length of the array of micromirror array lenses. The focal length may be adjusted by translating and/or rotating a micromirror.

In a prior art large projection display device, a large amount of light is consumed by the light source in order to provide proper brightness of image. However, using an array of micromirror array lenses, light beams may be steered and focused to an arbitrary location. Therefore, light efficiency and brightness of image may be increased by focusing all micromirrors to in-focused pixels if necessary.

The advantages of the present invention include improved brightness of image and increased light efficiency, resulting in lower power consumption.

While the invention has been shown and described with reference to different embodiments thereof, it will be appreciated by those skills in the art that variations in form, detail, compositions and operation may be made without departing from the spirit and scope of the invention as defined by the accompanying claims.

What is claimed is:

1. A display apparatus, comprising:
an array of micromirror array lenses, configured to focus incident light beams onto a two-dimensional screen;
wherein the two-dimensional screen is optically coupled to the array of micromirror array lenses, configured to display a two-dimensional image to be used by a volumetric three-dimensional display device, based at least in part on the incident light beams focused by the array of micromirror array lenses onto the two-dimensional screen.

2. The display apparatus of claim 1, wherein the optical axis of at least a portion of the array of micromirror array lenses is adjusted by at least one of the group consisting of translation of the at least a portion of the array of micromirror array lenses and rotation of the at least a portion of the array of micromirror array lenses.

3. The display apparatus of claim 1, wherein the micromirror of the array of micromirror array lenses is controlled independently.

4. The display apparatus of claim 3, wherein the optical axis of at least a portion of the array of micromirror array lenses is adjusted by at least one of the group consisting of translation of a micromirror and rotation of a micromirror.

5. The display apparatus of claim 1, wherein the focal length of at least a portion of the array of micromirror array lenses is adjusted by at least one of the group consisting of translation of a micromirror, and rotation of a micromirror.

6. A method in a display device, comprising:
focusing incident light beams onto a two-dimensional screen using an array of micromirror array lenses; and
displaying a two-dimensional image to be used by a volumetric three-dimensional display device, in response to the focusing of the incident light beams.

7. The method of claim 6, further comprising adjusting the optical axis of the array of micromirror array lenses.

8. The method of claim 7, wherein the adjusting of the optical axis is selected from the group consisting of translating a micromirror and rotating a micromirror.

9. The method of claim 6, further comprising adjusting the focal length of the array of micromirror array lenses.

10. The method of claim 9, wherein the adjusting of the focal length is selected from the group consisting of translating a micromirror and rotating a micromirror.
